(19) United States
(12) Patent Application Publication
(10) Pub. No.: US 2025/0350056 A1
(43) Pub. Date: Nov. 13, 2025

(54) WIRE HARNESS

(71) Applicant: YAZAKI CORPORATION, Tokyo (JP)

(72) Inventors: Toshiharu Takahashi, Makinohara-shi (JP); Takashi Matsunaga, Makinohara-shi (JP); Keigo Tsubo, Makinohara-shi (JP); Masayoshi Takayanagi, Makinohara-shi (JP); Shingo Hamada, Tokyo (JP); Daiki Amemiya, Tokyo (JP); Kenji Kajikawa, Tokyo (JP)

(21) Appl. No.: 19/277,410

(22) Filed: Jul. 23, 2025

Related U.S. Application Data
(63) Continuation of application No. PCT/JP2024/002126, filed on Jan. 25, 2024.

(30) Foreign Application Priority Data
Feb. 27, 2023 (JP) 2023-027924

(51) Int. Cl. H01R 12/77

(52) U.S. Cl. CPC H01R 12/774

(57) ABSTRACT

A wire harness includes a connector, a first flexible printed wiring board, a second flexible printed wiring board, and a holding member, the connector has a plurality of terminals and housings that retain the terminals, the terminals includes a first terminal group and a second terminal group, the first flexible printed wiring board includes a through-hole into which an insertion portion of the first terminal group is inserted, the second flexible printed wiring board includes a through-hole into which an insertion portion of the second terminal group is inserted, the holding member is attached to the housing and configured to retain the first flexible printed wiring board and the second flexible printed wiring board, and the holding member has an exit portion and causes the first flexible printed wiring board and the second flexible printed wiring board, overlapped with each other, to extend from the exit portion.

### CROSS-REFERENCE TO RELATED APPLICATION(S)

This application is a continuation application of International Application No. PCT/JP2024/002126 filed on Jan. 25, 2024 which claims the benefit of priority from Japanese Patent Application No. 2023-027924 filed on Feb. 27, 2023 and designating the U.S., the entire contents of which are incorporated herein by reference.

### BACKGROUND OF THE INVENTION

### 1. Field of the Invention

The present invention relates to a wire harness.

### 2. Description of the Related Art

Conventionally, a cable connection structure for a flat cable has been known. JP 4 667 996 B2 discloses a waterproof connector for a flat cable, which includes: a connector housing into which an end portion of a flat cable is introduced through an introduction hole provided at a base end portion, and which accommodates a terminal connected to the end portion of the flat cable; a seal member interposed between the flat cable and a peripheral wall that defines the introduction hole of the connector housing; a rear cover having an insertion hole through which the flat cable extending from the introduction hole of the connector housing is inserted and which is mounted on the base end portion of the connector housing while the flat cable is inserted through the insertion hole; and a fixing plate mounted on the rear cover to sandwich the flat cable inserted through the insertion hole of the rear cover between the fixing plate and the rear cover.

For a wire harness, in the case where multiple flat cables are connected to a single connector to increase the number of poles in the connector, it is desirable to improve the ease of handling of the wire harness.

### SUMMARY OF THE INVENTION

The present invention is intended to provide a wire harness with improved ease of handling.

In order to achieve the above mentioned object, a wire harness according to one aspect of the present invention includes a connector that includes a plurality of terminals and a housing, each of the terminals having a rod-shaped or tubular insertion portion, the housing retaining the terminals arranged in a plurality of rows aligned in a first direction with the insertion portion protruding, the terminals including a first terminal group disposed on a first side in the first direction and a second terminal group disposed on a second side in the first direction; a first flexible printed wiring board that includes a through-hole into which the insertion portion of the first terminal group is inserted and a printed circuit connected to the insertion portion of the first terminal group; a second flexible printed wiring board that includes a through-hole into which the insertion portion of the second terminal group is inserted and a printed circuit connected to the insertion portion of the second terminal group; and a holding member attached to the housing and configured to retain the first flexible printed wiring board and the second flexible printed wiring board, wherein the first flexible printed wiring board and the second flexible printed wiring board are overlapped with each other by bending at least one of the first flexible printed wiring board and the second flexible printed wiring board, and the holding member has an exit portion and causes the first flexible printed wiring board and the second flexible printed wiring board, overlapped with each other, to extend from the exit portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a wire harness and a mating connector in an embodiment;

FIG. 2 is a diagram illustrating the constituent components of the wire harness according to the embodiment;

FIG. 3 is a perspective view of an outer housing according to the embodiment;

FIG. 4 is a perspective view of an inner housing according to the embodiment;

FIG. 5 is a perspective view of a terminal according to the embodiment;

FIG. 6 is a perspective view of a first flexible printed wiring board according to the embodiment;

FIG. 7 is a perspective view illustrating a printed circuit of the first flexible printed wiring board according to the embodiment;

FIG. 8 is a perspective view of a second flexible printed wiring board according to the embodiment;

FIG. 9 is a perspective view illustrating a printed circuit of the second flexible printed wiring board according to the embodiment;

FIG. 10 is a perspective view of a cover according to the embodiment;

FIG. 11 is a diagram illustrating an operation of inserting the inner housing;

FIG. 12 is a diagram illustrating an operation of inserting the terminal;

FIG. 13 is a diagram illustrating an operation of installing the flexible printed wiring board;

FIG. 14 is a plan view of the installed flexible printed wiring board;

FIG. 15 is a diagram illustrating an operation of attaching the cover;

FIG. 16 is a diagram illustrating an operation of bending the wiring board;

FIG. 17 is a diagram illustrating an operation of retaining the wiring board;

FIG. 18 is a cross-sectional view of a wire harness according to the embodiment;

FIG. 19 is a diagram illustrating an operation of assembling a lever;

FIG. 20 is a diagram illustrating an operation of bending a wiring board according to a first modification of the embodiment;

FIG. 21 is a diagram illustrating an operation of retaining the wiring board according to the first modification of the embodiment;

FIG. 22 is a diagram illustrating an operation of assembling a lever according to the first modification of the embodiment;

FIG. 23 is a diagram illustrating an operation of assembling the lever according to the first modification of the embodiment;

FIG. 24 is a diagram illustrating an operation of assembling the lever according to the first modification of the embodiment;

FIG. 25 is a diagram illustrating a mating process according to the first modification of the embodiment;

FIG. 26 is a perspective view illustrating a wire harness completely mated with a mating connector;

FIG. 27 is a side view illustrating the wire harness completely mated with the mating connector;

FIG. 28 is a side view illustrating the wire harness completely mated with the mating connector;

FIG. 29 is a diagram illustrating an operation of bending the wiring board according to the first modification of the embodiment;

FIG. 30 is a diagram illustrating an operation of retaining the wiring board according to the first modification of the embodiment; and

FIG. 31 is a cross-sectional view of a wire harness according to a second modification of the embodiment.

### DETAILED DESCRIPTION OF THE PREFERRED EMBODIMENTS

A wire harness according to an embodiment of the present invention is now described in detail with reference to the drawings. Moreover, the present invention is not limited to embodiments described herein. Additionally, the components in the embodiments described below may include those readily conceivable by those skilled in the art or substantially identical ones.

### Embodiment

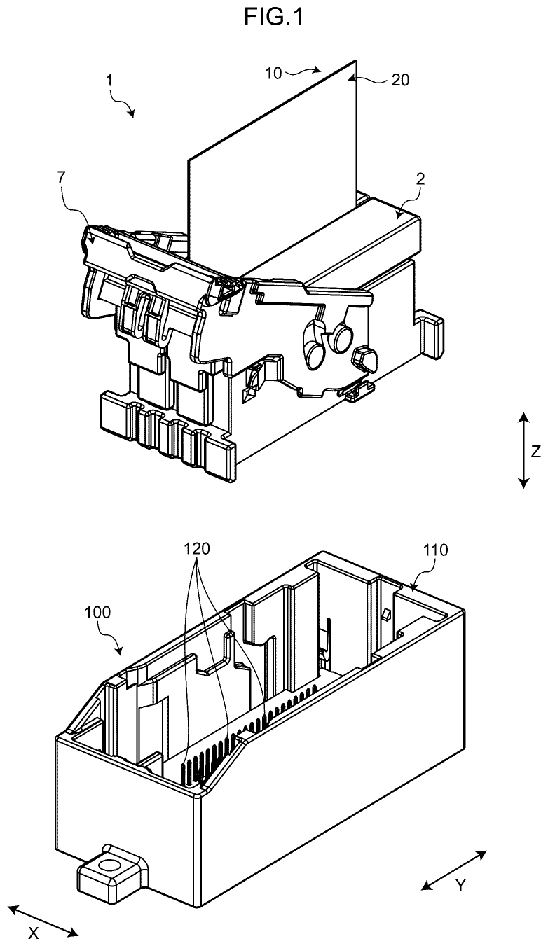

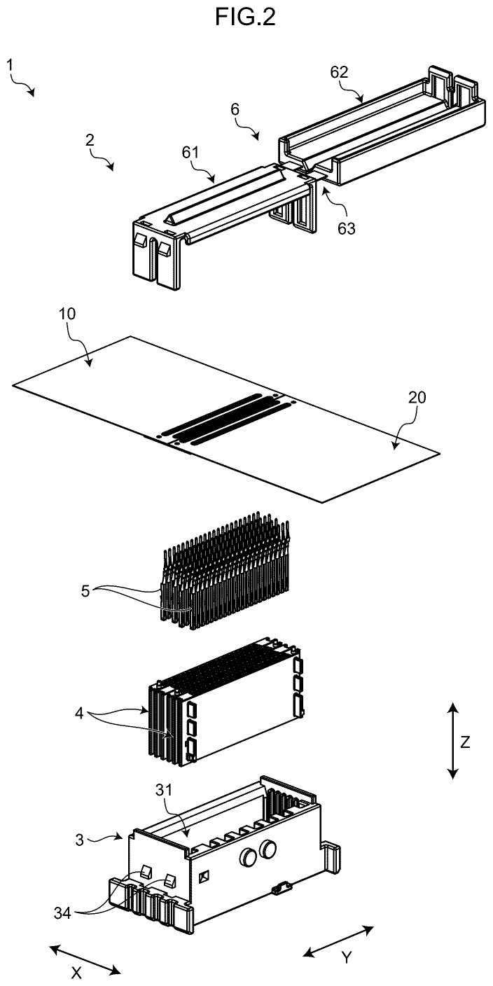

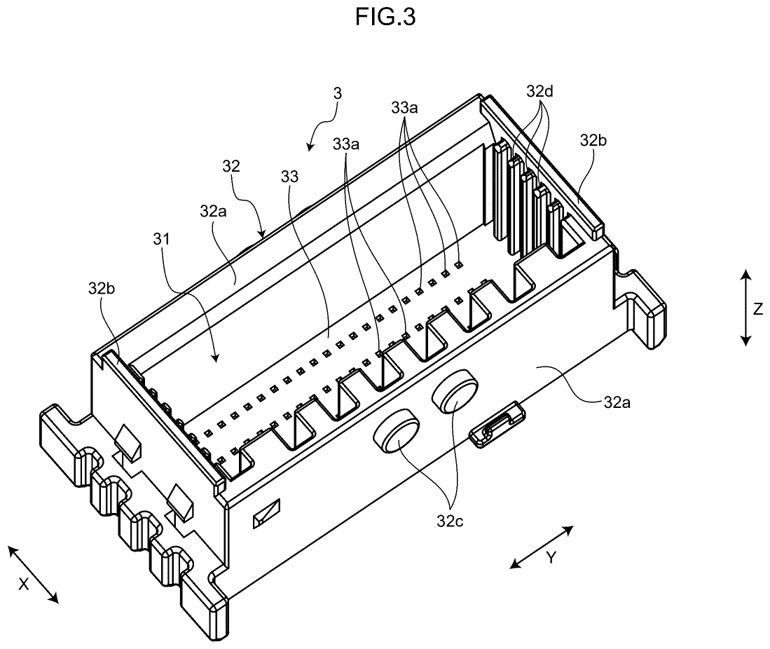

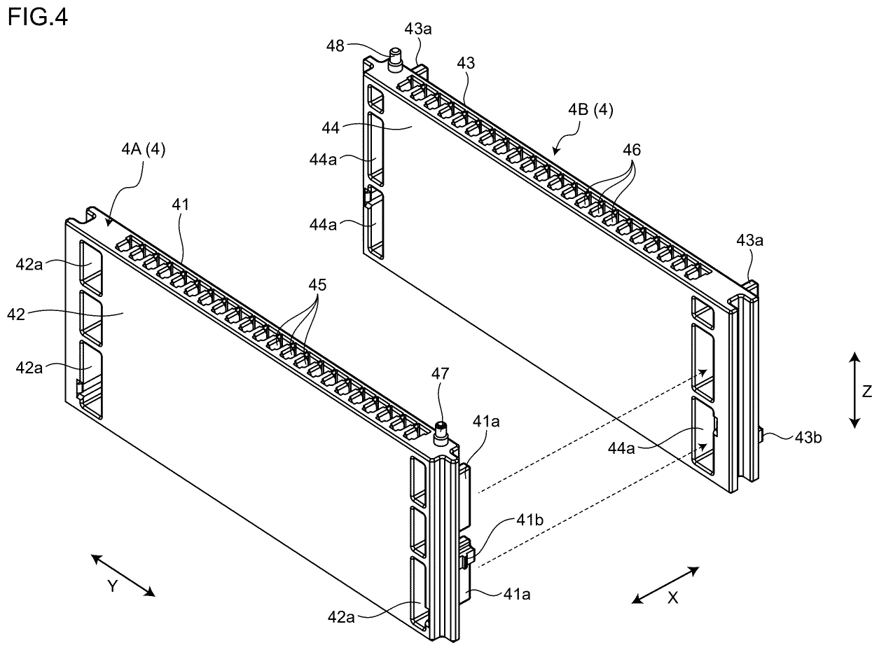

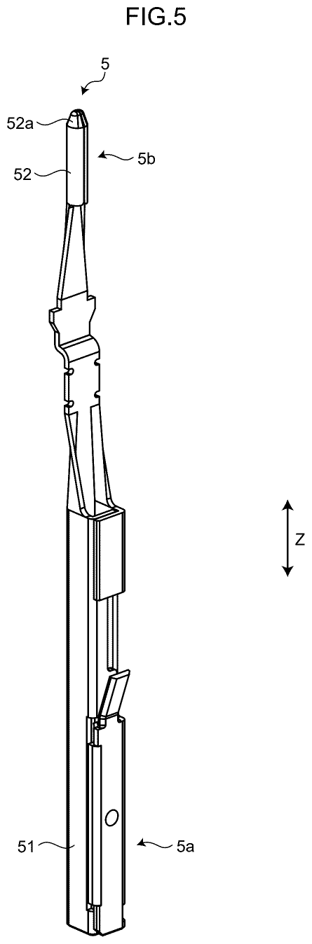

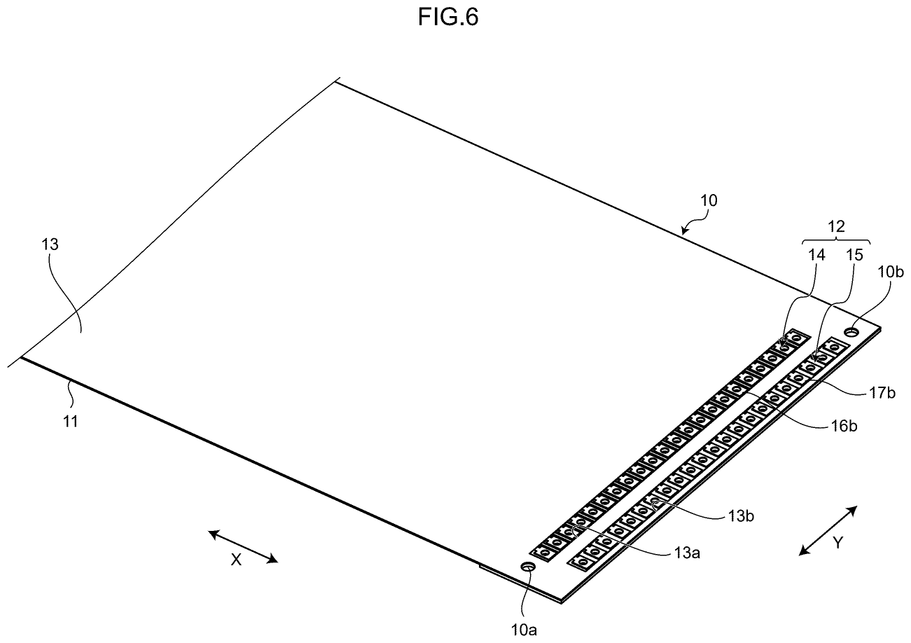

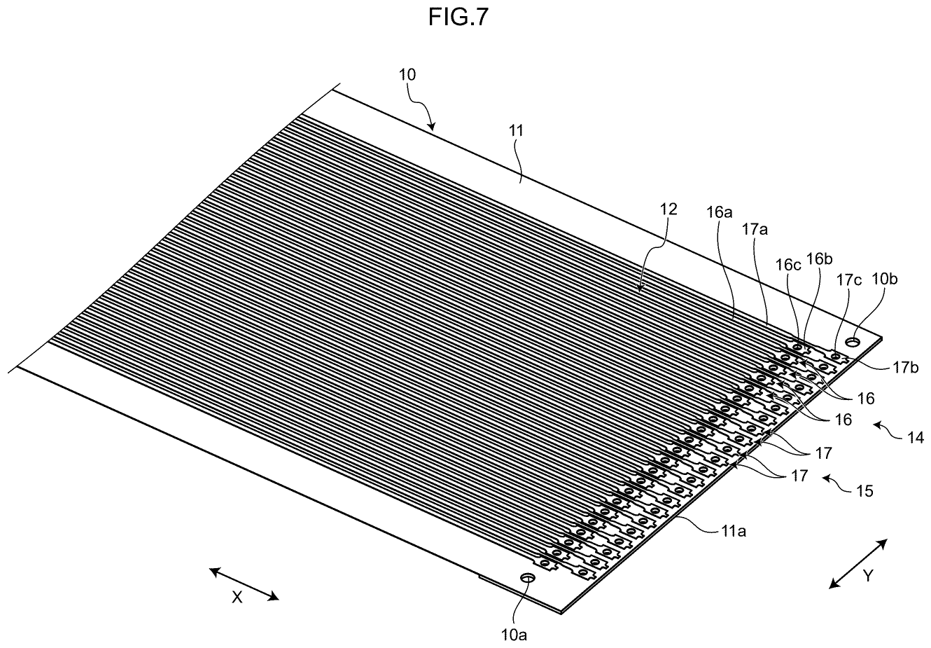

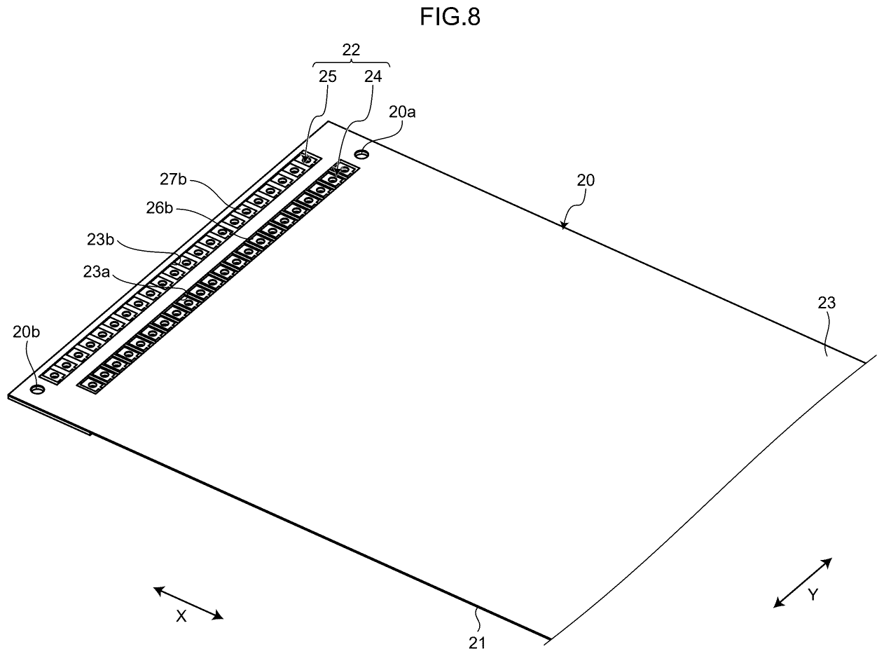

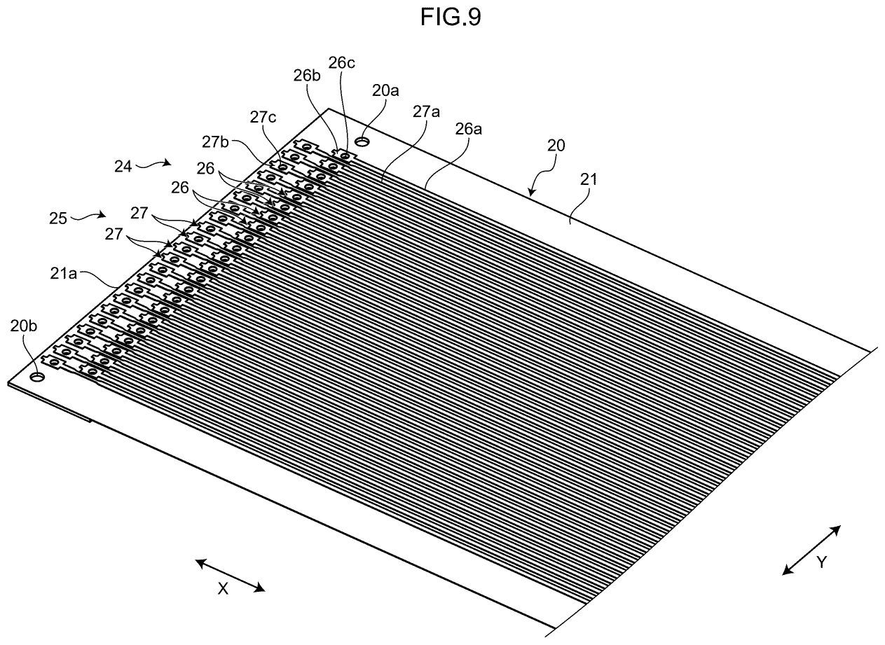

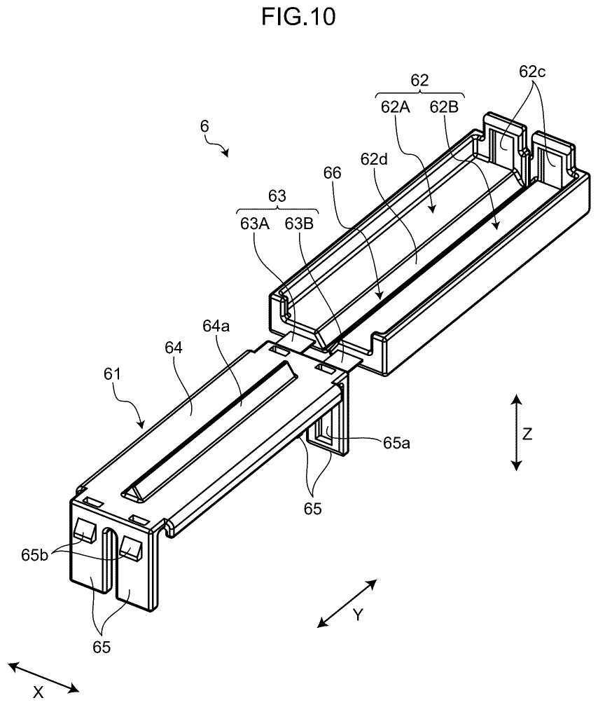

An embodiment is described with reference to FIGS. 1 to 19. The present embodiment relates to a wire harness. FIG. 1 is a perspective view illustrating a wire harness and a mating connector according to the present embodiment, FIG. 2 is a view illustrating the constituent components of the wire harness according to the present embodiment, FIG. 3 is a perspective view of an outer housing according to the present embodiment, FIG. 4 is a perspective view of an inner housing according to the present embodiment, FIG. 5 is a perspective view of a terminal according to the present embodiment, FIG. 6 is a perspective view of a first flexible printed wiring board according to the present embodiment, FIG. 7 is a perspective view illustrating a printed circuit of the first flexible printed wiring board according to the present embodiment, FIG. 8 is a perspective view of a second flexible printed wiring board according to the present embodiment, FIG. 9 is a perspective view illustrating a printed circuit of the second flexible printed wiring board according to the present embodiment, and FIG. 10 is a perspective view of a cover according to the present embodiment.

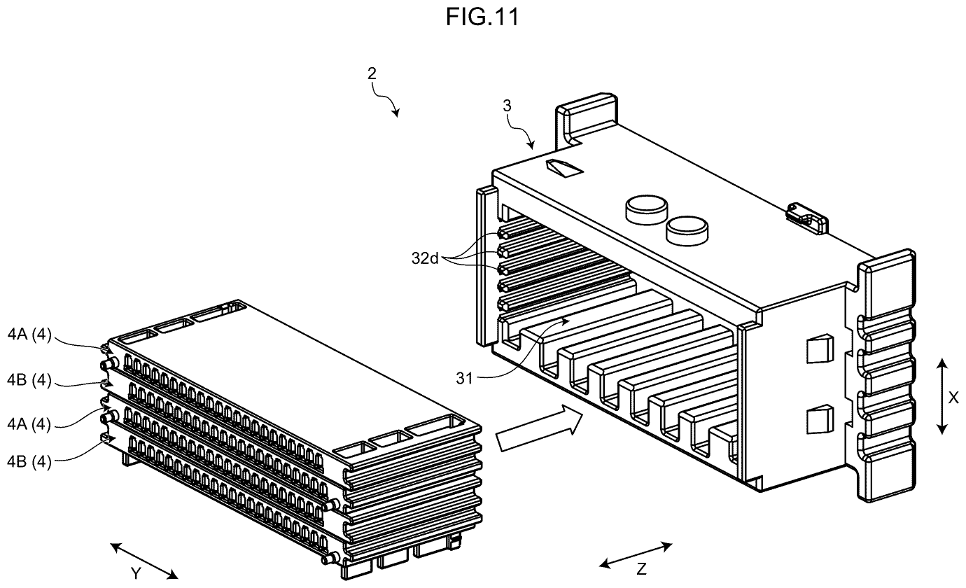

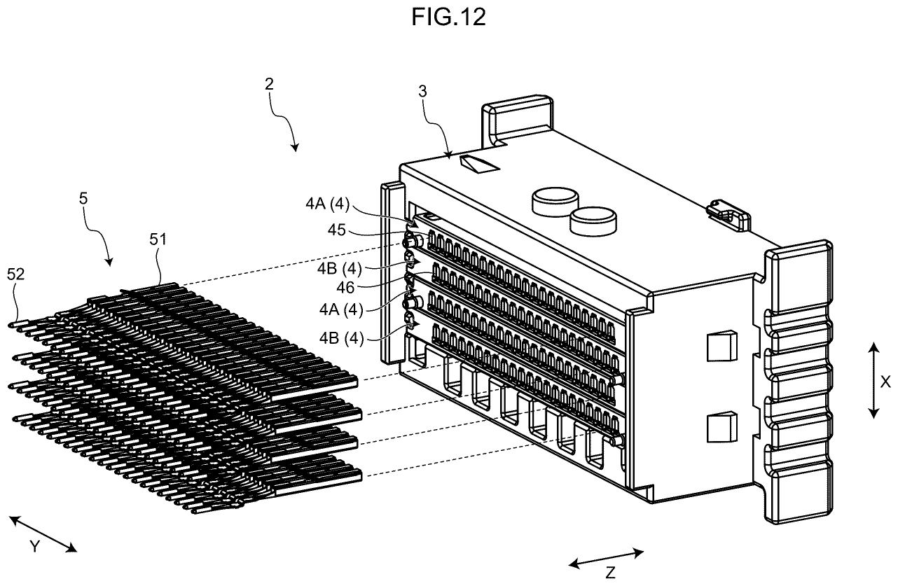

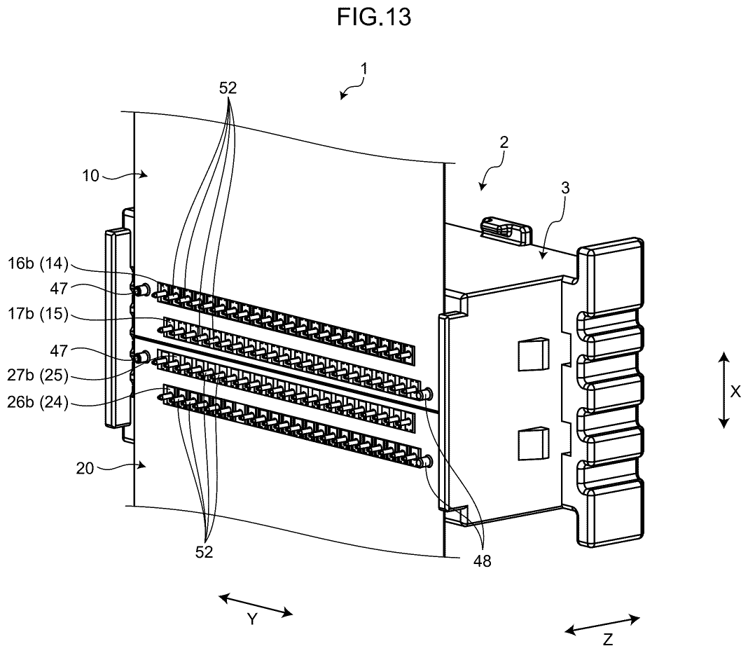

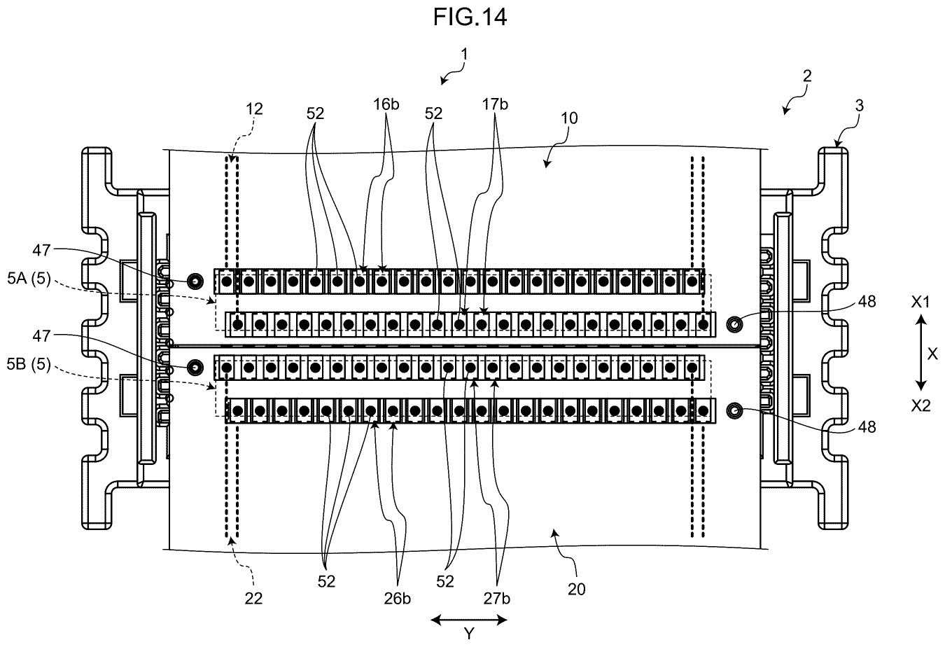

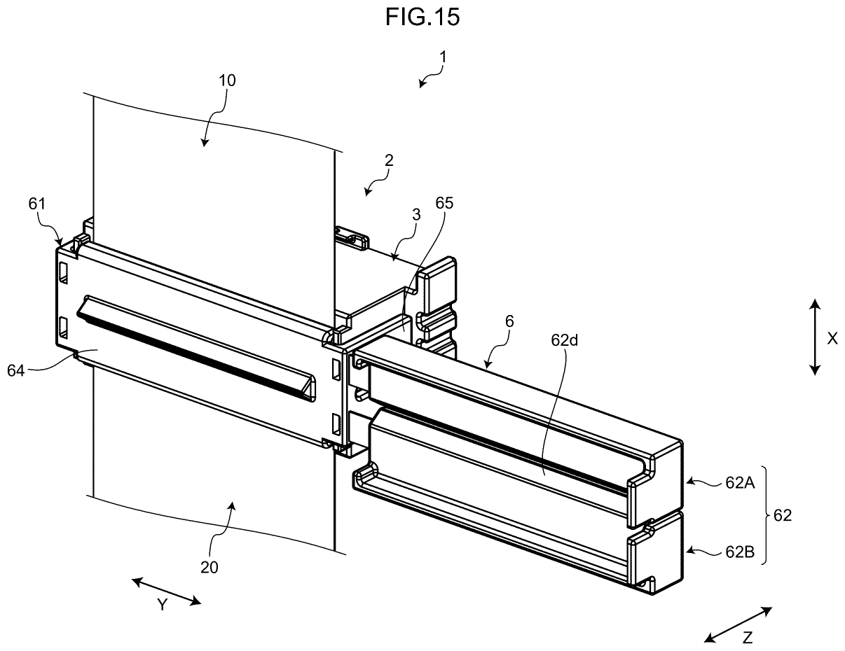

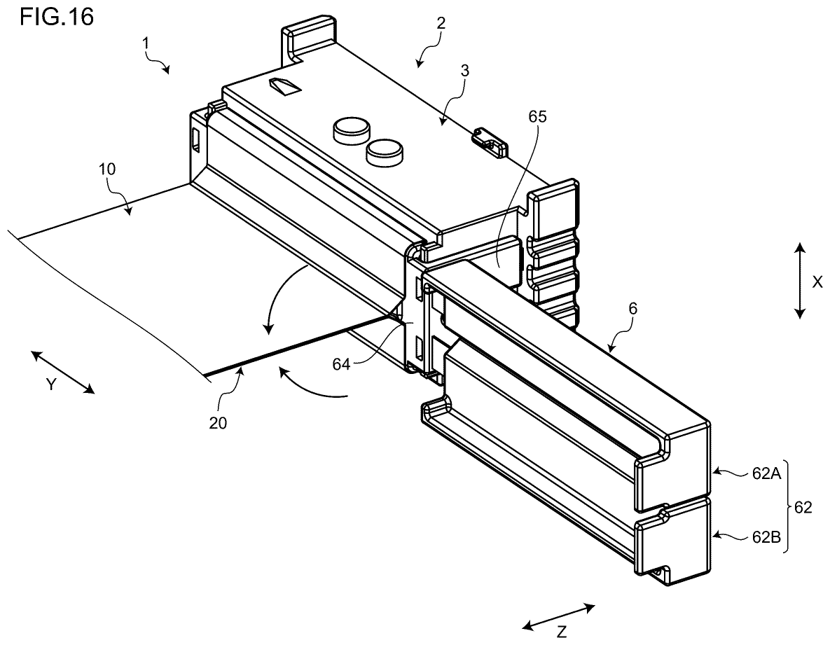

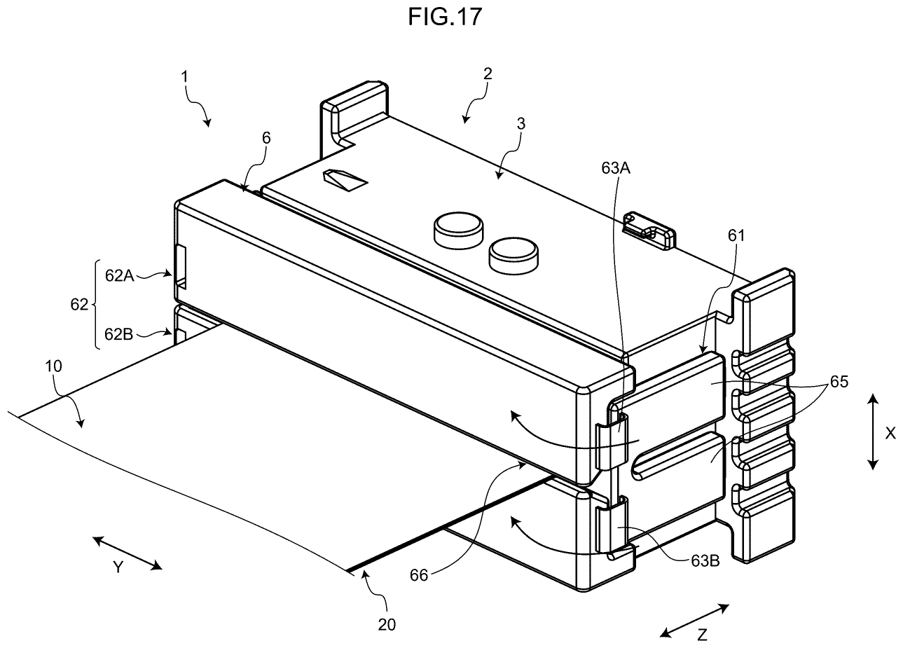

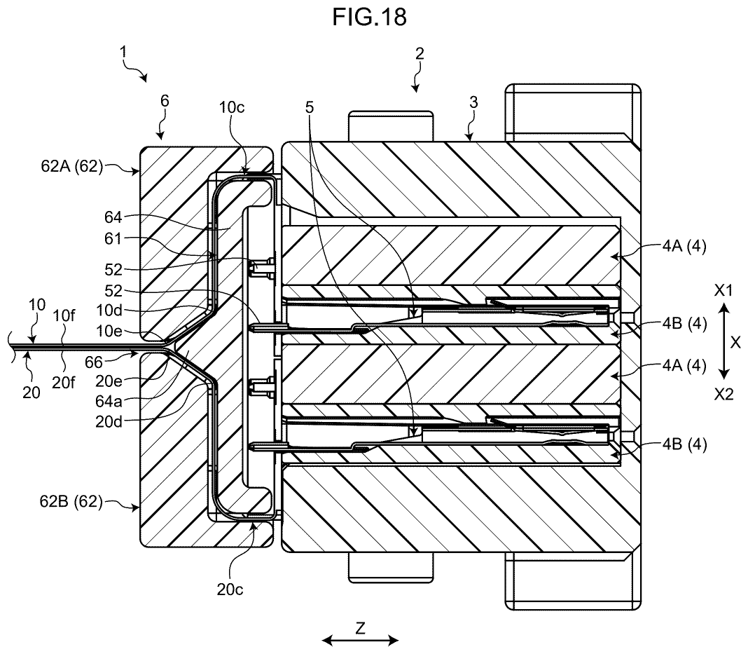

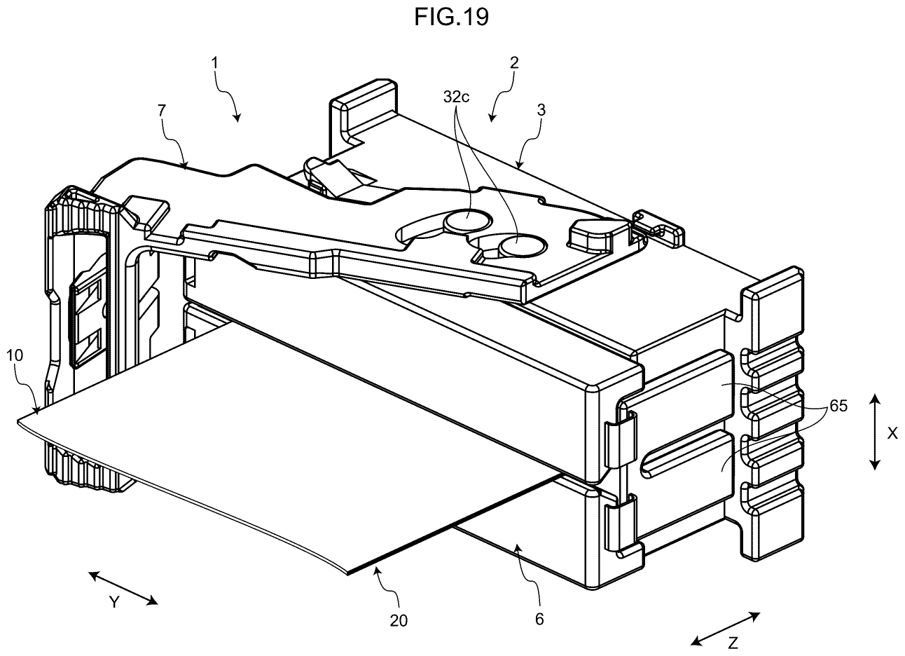

FIG. 11 is a diagram illustrating an operation of inserting the inner housing, FIG. 12 is a diagram illustrating an operation of inserting the terminal, FIG. 13 is a diagram illustrating an operation of installing the flexible printed wiring board, FIG. 14 is a plan view of the installed flexible printed wiring board, FIG. 15 is a diagram illustrating an operation of attaching the cover, FIG. 16 is a diagram illustrating an operation of bending the wiring board, FIG. 17 is a diagram illustrating an operation of retaining the wiring board, FIG. 18 is a cross-sectional view of the wire harness according to the present embodiment, and FIG. 19 is a diagram illustrating an operation of assembling a lever.

As illustrated in FIG. 1, a wire harness 1 according to the present embodiment includes a connector 2 and flexible printed wiring boards 10 and 20. The wire harness 1 is mounted, for example, in a vehicle such as an automobile. The wire harness 1 may be connected to equipment disposed in an instrument panel. The connector 2 is configured to mate with a mating connector 100. The mating connector 100 is disposed on a housing of equipment such as a display or a meter device. The wire harness 1 may connect equipment having the mating connector 100 to a control device that controls the equipment. The flexible printed wiring boards 10 and 20 each have a printed circuit with a power line and a signal line.

The mating connector 100 includes a housing 110 and a plurality of terminals 120 retained by the housing 110. The connector 2 connects the printed circuit of the flexible printed wiring boards 10 and 20 to the terminal 120. The illustrated connector 2 is a lever-type connector with a lever 7. The connector 2 is capable of being mated with the housing 110 of the mating connector 100 using a force-multiplying mechanism that includes the lever 7.

As illustrated in FIG. 2, the connector 2 includes an outer housing 3, a plurality of inner housings 4, a plurality of terminals 5, the first flexible printed wiring board 10, the second flexible printed wiring board 20, and a cover 6. The outer housing 3 and the inner housing 4 are molded, for example, from an insulating synthetic resin. The illustrated outer housing 3 has a rectangular tubular shape and includes an accommodation portion 31 that accommodates the multiple inner housings 4.

The inner housing 4 is a member that retains the terminals 5 and is used to arrange the terminals 5. The inner housing 4 includes a cavity into which the terminals 5 are inserted. The multiple inner housings 4 are stacked and accommodated in the accommodation portion 31 of the outer housing 3.

In the following description, the direction in which the multiple inner housings 4 are stacked is referred to as a “first direction X”. Additionally, the direction in which the inner housings 4 are inserted into the outer housing 3 is referred to as a “third direction Z”. The third direction Z is orthogonal to the first direction X. In addition, the direction orthogonal to both the first direction X and the third direction Z is referred to as a “second direction Y”. The second direction Y corresponds to the alignment direction of the terminals 5 in each inner housing 4. In the present embodiment, each inner housing 4 retains the multiple terminals 5 aligned linearly in the second direction Y.

The flexible printed wiring boards 10 and 20 are film-like circuit bodies having flexibility. The first flexible printed wiring board 10 and the second flexible printed wiring board 20 are wiring boards independent of each other. The terminals 5 are inserted into through-holes of the flexible printed wiring boards 10 and 20 and are joined to the printed circuits of the flexible printed wiring boards 10 and 20.

The cover 6 is attached to the outer housing 3 while covering a joint between the flexible printed wiring boards 10 and 20 and the terminals 5. The cover 6 of the present embodiment is configured to retain the flexible printed wiring boards 10 and 20 in a state in which the two flexible printed wiring boards 10 and 20 are overlapped on each other, as will be described later.

As illustrated in FIG. 3, the outer housing 3 includes a tubular portion 32 and a bottom wall 33. The tubular portion 32 has a rectangular tubular shape and includes a pair of main walls 32a and a pair of side walls 32b. The pair of main walls 32a face each other in the first direction X and extend in the second direction Y. A columnar shaft portion 32c is provided on the outer surface of the main wall 32a. The shaft portion 32c rotatably supports the lever 7.

The pair of side walls 32b face each other in the second direction Y and extend in the first direction X. A plurality of ribs 32d guiding the inner housing 4 is provided on the inner surface of the side wall 32b. The ribs 32d are protrusions that project in the second direction Y and extend linearly in the third direction Z.

The bottom wall 33 closes one end of the tubular portion 32. In other words, the outer housing 3 is a tubular member with a closed bottom. The tubular portion 32 and the bottom wall 33 form the accommodation portion 31. The bottom wall 33 is provided with a plurality of through-holes 33a. The terminals 120 of the mating connector 100 are inserted into the through-holes 33a and connected to the terminals 5. The multiple through-holes 33a is disposed in multiple rows. The through-holes 33a in each row are aligned in the second direction Y.

As illustrated in FIG. 4, the multiple inner housings 4 include a first-shaped housing 4A and a second-shaped housing 4B. The first-shaped housing 4A and the second-shaped housing 4B are rectangular flat plates. The first-shaped housing 4A includes a plurality of first cavities 45 to retain the terminals 5. The multiple first cavities 45 are aligned in the second direction Y and penetrate the first-shaped housing 4A along the third direction Z. The second-shaped housing 4B includes a plurality of second cavities 46 to retain the terminals 5. The second cavities 46 are aligned in the second direction Y and penetrate the second-shaped housing 4B along the third direction Z.

The first cavity 45 and the second cavity 46 are disposed with their positions shifted in the second direction Y. The second cavities 46 are positioned between two adjacent first cavities 45 in the second direction Y. Thus, the first cavities 45 and the second cavities 46 retain the multiple terminals 5 in a zigzag arrangement.

In the wire harness 1 of the present embodiment, the inclusion of the multiple stackable inner housings 4 allows adaptation to specification changes of the connector 2. For example, if different terminals 5 are used depending on the tab size of the terminals 120 of the mating connector 100, modifying the inner housing 4 enables adaptation to such specification changes.

The first-shaped housing 4A includes a first surface 41 and a second surface 42. The first surface 41 and the second surface 42 are two main surfaces of the first-shaped housing 4A and face in opposite directions. The second-shaped housing 4B includes a first surface 43 and a second surface 44. The first surface 43 and the second surface 44 are two main surfaces of the second-shaped housing 4B and face in opposite directions. The two housings 4A and 4B are stackable with the first surface 41 facing the second surface 44. Additionally, the two housings 4A and 4B are stackable with the first surface 43 facing the second surface 42. In other words, the first-shaped housing 4A and the second-shaped housing 4B are configured to be stackable by overlapping each other alternately.

The first-shaped housing 4A includes a first protrusion 41a and a first recess 42a. The first protrusion 41a is provided on the first surface 41. The first recess 42a is provided on the second surface 42. The second-shaped housing 4B includes a second protrusion 43a and a second recess 44a. The second protrusion 43a is provided on the first surface 43. The second recess 44a is provided on the second surface 44. The first protrusion 41a can be mated with the second recess 44a, and the second protrusion 43a can be mated with the first recess 42a. The first protrusion 41a is provided with an engagement portion 41b that engages with the second recess 44a. Similarly, the second protrusion 43a is provided with an engagement portion 43b that engages with the first recess 42a.

The first-shaped housing 4A is provided with a first support protrusion 47. The second-shaped housing 4B is provided with a second support protrusion 48. The support protrusions 47 and 48 are inserted into the flexible printed wiring boards 10 and 20 to minimize stress on the printed circuit and the joint. The first support protrusion 47 is disposed at one end in the second direction Y, and the second support protrusion 48 is disposed at the other end in the second direction Y.

As illustrated in FIG. 5, the terminal 5 includes a connection portion 51 and an insertion portion 52. The terminal 5 is formed from a conductive metal plate. The connection portion 51 is disposed at a first end portion 5a of the terminal 5, and the insertion portion 52 is disposed at a second end portion 5b of the terminal 5. The connection portion 51 is a portion that is connected to the terminal 120 of the mating connector 100. The illustrated connection portion 51 has a rectangular tubular shape into which the terminal 120 is inserted. The connection portion 51 is inserted and retained in the cavities 45 and 46 of the inner housing 4.

The insertion portion 52 is a portion that is inserted into a through-hole of each of the flexible printed wiring boards 10 and 20. The insertion portion 52 has a tubular shape. A tapered portion 52a with a gradually narrowing shape is provided at a distal end of the insertion portion 52. Moreover, the insertion portion 52 may be a solid rod without an internal space and may, for example, have a columnar shape.

As illustrated in FIG. 6, the first flexible printed wiring board 10 includes a base film 11, a printed circuit 12, and a coverlay 13. The base film 11 and the coverlay 13 are insulating films composed of a synthetic resin. The printed circuit 12 is a conductive metal foil formed on the base film 11. The coverlay 13 covers the pattern of the printed circuit 12 and includes openings 13a and 13b, which expose lands 16b and 17b, respectively.

As illustrated in FIG. 7, the printed circuit 12 includes a first circuit group 14 and a second circuit group 15. The first circuit group 14 includes a plurality of circuits 16 extending in the first direction X. The multiple circuits 16 are arranged in the second direction Y. The second circuit group 15 includes a plurality of circuits 17 extending in the first direction X. The multiple circuits 17 are arranged in the second direction Y. The printed circuit 12 is configured such that one circuit 16 of the first circuit group 14 and one circuit 17 of the second circuit group 15 are alternately aligned.

The circuit 16 includes a pattern 16a and the land 16b provided at an end portion of the pattern 16a. The circuit 17 includes a pattern 17a and the land 17b provided at an end portion of the pattern 17a. The multiple lands 16b are aligned in a straight line along the second direction Y. The multiple lands 17b are aligned in a straight line along the second direction Y. In the first direction X, the position of the lands 17b is shifted with respect to the position of the lands 16b. More specifically, the lands 17b protrude toward an edge 11a of the base film 11 with respect to the lands 16b. Thus, the pattern 17a passes between two adjacent lands 16b.

The land 16b has a through-hole 16c formed therein into which the insertion portion 52 of the terminal 5 is inserted. The through-hole 16c penetrates the base film 11. Similarly, the land 17b has a through-hole 17c formed therein. The through-hole 17c penetrates the base film 11. The through-holes 16c and 17c are disposed in a sawtooth zigzag pattern on the first flexible printed wiring board 10. As illustrated in FIG. 6, the opening 13a of the coverlay 13 exposes the land 16b of the first circuit group 14. The opening 13b exposes the land 17b of the second circuit group 15.

The first flexible printed wiring board 10 is provided with two through-holes 10a and 10b. The two through-holes 10a and 10b are disposed at the end portion in the second direction Y with the printed circuit 12 positioned between these through-holes. The through-hole 10a is aligned with the opening 13a and is disposed on an extension line in the second direction Y of the multiple lands 16b. The through-hole 10b is aligned with the opening 13b and is disposed on an extension line in the second direction Y of the multiple lands 17b. The support protrusion 47 of the first-shaped housing 4A is inserted into one of the two through-holes 10a and 10b. The support protrusion 48 of the second-shaped housing 4B is inserted into the other of the two through-holes 10a and 10b.

The second flexible printed wiring board 20 has a similar configuration to the first flexible printed wiring board 10. As illustrated in FIG. 8, the second flexible printed wiring board 20 includes a base film 21, a printed circuit 22, and a coverlay 23. The coverlay 23 covers the pattern of the printed circuit 22 and includes openings 23a and 23b, which expose the lands 26b and 27b, respectively.

As illustrated in FIG. 9, the printed circuit 22 includes a first circuit group 24 and a second circuit group 25. The first circuit group 24 includes a plurality of circuits 26 extending in the first direction X. The multiple circuits 26 are arranged in the second direction Y. The second circuit group 25 includes a plurality of circuits 27 extending in the first direction X. The multiple circuits 27 are arranged in the second direction Y. The printed circuit 22 is configured such that one circuit 26 of the first circuit group 24 and one circuit 27 of the second circuit group 25 are alternately aligned.

The circuit 26 has a pattern 26a and the land 26b provided at an end portion of the pattern 26a. The circuit 27 has a pattern 27a and the land 27b provided at an end portion of the pattern 27a. The multiple lands 26b and the multiple lands 27b are aligned in a straight line along the second direction Y. The land 27b protrudes toward an edge 21a of the base film 21 with respect to the land 26b. The pattern 27a passes between two adjacent lands 26b.

The land 26b has a through-hole 26c formed therein into which the insertion portion 52 of the terminal 5 is inserted. The land 27b has a through-hole 27c formed therein. In other words, the through-holes 26c and 27c are disposed in a sawtooth zigzag pattern on the second flexible printed wiring board 20. As illustrated in FIG. 8, the opening 23a of the coverlay 23 exposes the land 26b of the first circuit group 24. The opening 23b exposes the land 27b of the second circuit group 25.

The second flexible printed wiring board 20 is provided with two through-holes 20a and 20b. The two through-holes 20a and 20b are disposed at the end portions in the second direction Y with the printed circuit 22 positioned between these through-holes. The through-hole 20a is aligned with the opening 23a and is disposed on an extension line in the second direction Y of the multiple lands 26b. The through-hole 20b is aligned with the opening 23b and is disposed on an extension line in the second direction Y of the multiple lands 27b. The support protrusion 47 of the first-shaped housing 4A is inserted into one of the two through-holes 20a and 20b. The support protrusion 48 of the second-shaped housing 4B is inserted into the other of the two through-holes 20a and 20b.

As illustrated in FIG. 2, the cover 6 includes a main body 61, a holding portion 62, and a hinge portion 63. The cover 6 is molded, for example, from an insulating synthetic resin. The main body 61 is a portion that covers a joint between the flexible printed wiring boards 10 and 20 and the terminals 5 and engages with the outer housing 3. The holding portion 62 is a portion that sandwiches and retains the flexible printed wiring boards 10 and 20 between the holding portion 62 and the main body 61. The hinge portion 63 connects the main body 61 and the holding portion 62 and has flexibility.

As illustrated in FIG. 10, the main body 61 includes a covering portion 64, which covers the joint, and four leg portions 65. The covering portion 64 is shaped like a rectangular flat plate. The leg portions 65 are disposed at both end portions of the covering portion 64 in the second direction Y. The leg portion 65 is a portion that engages with the outer housing 3 and protrudes from the covering portion 64 in the third direction Z. The leg portion 65 is provided with an engagement recess 65a and an engagement protrusion 65b. The engagement recess 65a is formed on the inner side of the leg portion 65 that faces the outer housing 3. The engagement recess 65a is provided on each of the four leg portions 65. As illustrated in FIG. 2, an engagement protrusion 34 is provided on the outer side of the outer housing 3. The engagement recess 65a of the cover 6 engages with the engagement protrusion 34.

The engagement protrusion 65b engages with the holding portion 62 to lock the holding portion 62. The engagement protrusion 65b is provided on two adjacent leg portions 65. The engagement protrusion 65b protrudes in the second direction Y from the outer surface, which is the surface opposite to the side where the engagement recess 65a is located.

The holding portion 62 is aligned with the main body 61 in the second direction Y. The holding portion 62 includes a first holding portion 62A and a second holding portion 62B. The first holding portion 62A and the second holding portion 62B are aligned in the first direction X. The first holding portion 62A and the second holding portion 62B are rectangular in shape in a plan view. A slit 66 is provided between the first holding portion 62A and the second holding portion 62B. This configuration makes the first holding portion 62A and the second holding portion 62B independent of each other. The first holding portion 62A retains the first flexible printed wiring board 10. The second holding portion 62B retains the second flexible printed wiring board 20.

The hinge portion 63 is disposed at the end portion of the main body 61 opposite to the side where the engagement protrusion 65b is located. The hinge portion 63 includes a first hinge portion 63A and a second hinge portion 63B. The first hinge portion 63A connects the first holding portion 62A to the main body 61, while the second hinge portion 63B connects the second holding portion 62B to the main body 61. The hinge portion 63 extends in the second direction Y from an end portion of the covering portion 64 in the second direction Y. The end portions of each of the first holding portion 62A and the second holding portion 62B are provided with an engagement portion 62c that engages with the engagement protrusion 65b.

The covering portion 64 is provided with a rib 64a that restricts the bending shape of the flexible printed wiring boards 10 and 20. The rib 64a is disposed on a surface facing the holding portion 62 and extends in the second direction Y. The cross-sectional shape of the illustrated rib 64a is triangular. In other words, the cross-sectional shape of the rib 64a is tapered such that the width in the first direction X decreases toward the distal end in the protruding direction. The first holding portion 62A and the second holding portion 62B are provided with an inclined surface 62d corresponding to the rib 64a. The inclined surface 62d is disposed at the end portion adjacent to the slit 66. The rib 64a and the inclined surface 62d make the bending angle of the flexible printed wiring boards 10 and 20 an obtuse.

The following describes a method of manufacturing the wire harness 1 according to the present embodiment. The method of manufacturing the wire harness includes an operation of inserting the inner housing, an operation of inserting the terminal, an operation of installing the flexible printed wiring board, an operation of joining, an operation of attaching the cover, an operation of restricting the direction of the wiring board, and an operation of assembling the lever.

FIG. 11 illustrates the operation of inserting the inner housing. In this operation, the multiple stacked inner housings 4 are inserted into the outer housing 3. The first-shaped housings 4A and the second-shaped housings 4B are alternately stacked and inserted into the outer housing 3. The illustrated connector 2 includes two first-shaped housings 4A and two second-shaped housings 4B. The multiple inner housings 4 are inserted into the accommodation portion 31 along the third direction Z while being guided by the rib 32d. The multiple inner housings 4 are retained by the accommodation portion 31. The inner housings 4 may include an engagement portion that engages with the outer housing 3.

FIG. 12 illustrates the operation of inserting the terminal. The multiple terminals 5 are inserted into the cavity 45 of the first-shaped housing 4A and the cavity 46 of the second-shaped housing 4B. The connection portion 51 of the terminal 5 is inserted into the cavities 45 and 46. The inner housing 4 retains the connection portion 51 with the insertion portion 52 of the terminal 5 protruding from the cavities 45 and 46. This results in the formation of four rows of insertion portions 52 aligned in the second direction Y. The four rows are aligned in the first direction X.

FIG. 13 illustrates the operation of installing the flexible printed wiring board. In this operation, the insertion portion 52 of the terminal 5 is inserted into the first flexible printed wiring board 10 and the second flexible printed wiring board 20. More specifically, two rows of insertion portions 52 are inserted into the first flexible printed wiring board 10, while the other two rows of insertion portions 52 are inserted into the second flexible printed wiring board 20. The insertion portion 52 corresponding to the first flexible printed wiring board 10 is inserted into the land 16b of the first circuit group 14 and the land 17b of the second circuit group 15. The insertion portion 52 corresponding to the second flexible printed wiring board 20 is inserted into the land 26b of the first circuit group 24 and the land 27b of the second circuit group 25. Furthermore, the support protrusions 47 and 48 are inserted into the through-holes of the flexible printed wiring boards 10 and 20.

As illustrated in FIG. 14, the multiple terminals 5 include a first terminal group 5A and a second terminal group 5B. The first terminal group 5A is a group of the terminals 5 connected to the first flexible printed wiring board 10. The first terminal group 5A includes two rows of terminals 5 aligned along the second direction Y. The first terminal group 5A is constituted of terminals that are disposed on a first side X1 among the multiple terminals 5 of the connector 2. The second terminal group 5B is a group of the terminals 5 connected to the second flexible printed wiring board 20. The second terminal group 5B includes two rows of terminals 5 aligned along the second direction Y. The second terminal group 5B is constituted of terminals that are disposed on a second side X2 among the multiple terminals 5 of the connector 2.

The first flexible printed wiring board 10 includes the lands 16b and 17b connected to the insertion portions 52 of the first terminal group 5A. As illustrated in FIG. 7, the lands 16b and 17b include the through-holes 16c and 17c, respectively. The insertion portion 52 of the first terminal group 5A is inserted into the through-holes 16c and 17c. As illustrated in FIG. 14, one row of the insertion portions 52 of the first terminal group 5A is inserted into the land 16b, and the other row of the insertion portions 52 is inserted into the land 17b.

The second flexible printed wiring board 20 includes the lands 26b and 27b connected to the insertion portion 52 of the second terminal group 5B. As illustrated in FIG. 9, the lands 26b and 27b include the through-holes 26c and 27c, respectively. The insertion portion 52 of the second terminal group 5B is inserted into the through-holes 26c and 27c. As illustrated in FIG. 14, one row of the insertion portions 52 of the second terminal group 5B is inserted into the land 26b, and the other row of the insertion portions 52 is inserted into the land 27b.

The joining operation is the process of joining the insertion portion 52 of the terminals 5 to the lands 16b, 17b, 26b, and 27b. In the wire harness 1 of the present embodiment, the insertion portion 52 is soldered to the lands 16b, 17b, 26b, and 27b. Solder paste may be pre-applied to the lands 16b, 17b, 26b, and 27b. In this case, during the joining operation, soldering may be performed by irradiating the solder paste with laser light. For example, all the lands 16b, 17b, 26b, and 27b may be joined to the insertion portions 52 in a single irradiation. However, the soldering technique is not limited to the irradiation of laser light and may instead be performed using a reflow furnace or any other suitable technique.

The printed circuit 12 of the first flexible printed wiring board 10 extends from the first terminal group 5A toward the first side X1. The printed circuit 22 of the second flexible printed wiring board 20 extends from the second terminal group 5B toward the second side X2. In the wire harness 1 illustrated in FIG. 14, the first side X1 is one side in the first direction X, and the second side X2 is the other side in the first direction X. In other words, the two printed circuits 12 and 22 extend in opposite directions from each other.

In the operation of attaching the cover, as illustrated in FIG. 15, the main body 61 of the cover 6 is attached to the outer housing 3. The covering portion 64 of the main body 61 covers and protects the joint between the flexible printed wiring boards 10 and 20 and the terminals 5. In other words, the covering portion 64 covers and protects the insertion portion 52 of the terminal 5 and the lands 16b, 17b, 26b, and 27b of the flexible printed wiring boards 10 and 20. In assembling the main body 61 to the outer housing 3, the holding portion 62 is positioned at a position shifted in the second direction Y relative to the flexible printed wiring boards 10 and 20.

The operation of restricting the direction of the wiring board includes an operation of bending the wiring board and an operation of retaining the wiring board. FIG. 16 is a diagram illustrated to describe the operation of bending the wiring board. In the operation of bending the wiring board, the first flexible printed wiring board 10 and the second flexible printed wiring board 20 are bended in such a way as to overlap each other. The two flexible printed wiring boards 10 and 20 are bended in a manner that wraps around the covering portion 64 and are overlapped with the coverlays 13 and 23 facing each other. In other words, the two flexible printed wiring boards 10 and 20 are bended into a U-shape at 180° along the covering portion 64.

FIG. 17 is a diagram illustrated to describe the operation of retaining the wiring board. In the operation of retaining the wiring board, the two flexible printed wiring boards 10 and 20 are retained by the holding portion 62 of the cover 6. The cover 6 of the present embodiment retains the two flexible printed wiring boards 10 and 20 in an overlapping arrangement.

The first holding portion 62A engages with the main body 61 while bending the first hinge portion 63A. The first holding portion 62A sandwiches the first flexible printed wiring board 10 between the first holding portion 62A and the main body 61. The second holding portion 62B engages with the main body 61 while bending the second hinge portion 63B. The second holding portion 62B sandwiches the second flexible printed wiring board 20 between the second holding portion 62B and the main body 61. The two flexible printed wiring boards 10 and 20 are drawn out to the exterior through the slit 66 between the first holding portion 62A and the second holding portion 62B.

The slit 66 is used as an exit portion to cause the overlapped flexible printed wiring boards 10 and 20 to extend. The extension direction of the flexible printed wiring boards 10 and 20 is the third direction Z. More specifically, the flexible printed wiring boards 10 and 20 extend from the holding portion 62 along the third direction z, toward the side opposite to the outer housing 3. In other words, the flexible printed wiring boards 10 and 20 extend from the holding portion 62 in the direction in which the insertion portion 52 of the terminal 5 protrudes from the inner housing 4.

FIG. 18 illustrates the bending shape of the flexible printed wiring boards 10 and 20. As illustrated in FIG. 18, the first flexible printed wiring board 10 is retained by the cover 6 with a first curved portion 10c, a second curved portion 10d, and a third curved portion 10e. The first curved portion 10c is curved into a U-shape along the covering portion 64. The second curved portion 10d is formed in a portion where the rib 64a of the covering portion 64 rises. The third curved portion 10e is formed at the distal end of the rib 64a. The gap between the covering portion 64 and the first holding portion 62A is bent to form the second curved portion 10d and the third curved portion 10e on the first flexible printed wiring board 10. The interior angles of the first curved portion 10c and the second curved portion 10d are obtuse angles. The second flexible printed wiring board 20 is retained by the cover 6 having a first curved portion 20c, a second curved portion 20d, and a third curved portion 20e. The first curved portion 20c is curved into a U-shape along the covering portion 64. The two first curved portions 10c and 20c are curved toward opposite sides. In other words, the first curved portion 10c of the first flexible printed wiring board 10 has a curved shape that is convex toward the first side X1. On the other hand, the first curved portion 20c of the second flexible printed wiring board 20 has a curved shape that is convex toward the second side X2. The second curved portion 20d is formed in the portion where the rib 64a rises. The third curved portion 20e is formed at the distal end of the rib 64a. The interior angles of the second curved portion 20d and the third curved portion 20e are obtuse angles.

The two flexible printed wiring boards 10 and 20 are overlapped at the third curved portions 10e and 20e and extend in the third direction Z. The cover 6 of the present embodiment is configured to prevent excessive bending in the flexible printed wiring boards 10 and 20. For example, in the covering portion 64, the corners corresponding to the first curved portions 10c and 20c are chamfered into an arc shape. In addition, the portions forming the second curved portions 10d and 20d and the third curved portions 10e and 20e are bent at an angle larger than a right angle. Thus, the cover 6 of the present embodiment can restrict the path of the flexible printed wiring boards 10 and 20 without causing excessive bending in the flexible printed wiring boards 10 and 20.

In this way, the cover 6 of the present embodiment not only has the function of protecting the joint between the flexible printed wiring boards 10 and 20 and the terminals 5, but also has the function of restricting the path of the flexible printed wiring boards 10 and 20. The cover 6 causes the two flexible printed wiring boards 10 and 20 to be overlapped and extend. Overlapping the two flexible printed wiring boards 10 and 20 makes it easier to handle the connector 2. The two flexible printed wiring boards 10 and 20 are connected to equipment via a connector or the like. The two flexible printed wiring boards 10 and 20 may be connected to the same equipment or may be connected to different equipment.

FIG. 19 illustrates the connector 2 to which the lever 7 is attached. In the operation of assembling the lever, the lever 7 is attached to the outer housing 3. The connector 2 to which the lever 7 is attached is mated with the mating connector 100. The lever 7 amplifies the force applied to the lever 7 and transmits the force to the mating connector 100, causing the mating connector 100 to be mated to the outer housing 3.

As described above, the wire harness 1 of the present embodiment includes the connector 2, the first flexible printed wiring board 10, the second flexible printed wiring board 20, and the cover 6 acting as a holding member. The connector 2 includes the multiple terminals 5, each having a rod-shaped or tubular insertion portion 52, and the housings 3 and 4 configured to retain the multiple terminals 5 arranged in multiple rows with the insertion portion 52 protruding. The multiple rows are aligned in the first direction X. The multiple terminals 5 include the first terminal group 5A disposed on the first side X1 of the first direction X, and the second terminal group 5B disposed on the second side X2 of the first direction X.

The first flexible printed wiring board 10 includes the through-holes 16c and 17c into which the insertion portion 52 of the first terminal group 5A is inserted and includes the printed circuit 12 connected to the insertion portion 52 of the first terminal. The second flexible printed wiring board 20 includes the through-holes 26c and 27c into which the insertion portion 52 of the second terminal group 5B is inserted and includes the printed circuit 22 connected to the insertion portion 52 of the second terminal group 5B. The cover 6 acting as a holding member is attached to the housings 3 and 4 and retains the first flexible printed wiring board 10 and the second flexible printed wiring board 20.

The cover 6 includes the exit portion to cause the first flexible printed wiring board 10 and the second flexible printed wiring board 20, overlapping each other, to extend from the exit portion. The exit portion of the cover 6 is, for example, the slit 66. In the wire harness 1 of the present embodiment, the two flexible printed wiring boards 10 and 20 are overlapped and extended by the holding member. Thus, the wire harness 1 of the present embodiment is capable of improving the ease of handling of the wire harness 1. For example, by having the two flexible printed wiring boards 10 and 20 bundled together, it is possible for the wire harness 1 to be easily handled during transportation and routing. The two overlapped flexible printed wiring boards 10 and 20 may be routed in the same path as they are, or may be routed in different paths, or may branch off along the way.

The cover 6 of the present embodiment retains the first flexible printed wiring board 10 and the second flexible printed wiring board 20 in respective bended states, and causes the first flexible printed wiring board 10 and the second flexible printed wiring board 20, overlapped with each other, to extend from the exit portion in the protruding direction of the insertion portion 52. Such a configuration is used, for example, in the case where the flexible printed wiring boards 10 and 20 are routed along the protruding direction of the insertion portion 52.

The cover 6 of the present embodiment includes the main body 61 attached to the housings 3 and 4 so as to cover the insertion portion 52, the holding portion 62, and the hinge portion 63 that connects the main body 61 and the holding portion 62. The cover 6 causes the first flexible printed wiring board 10 and the second flexible printed wiring board 20 to overlap by sandwiching the first flexible printed wiring board 10 and the second flexible printed wiring board 20 between the main body 61 and the holding portion 62. The cover 6 of the present embodiment has not only the function of retaining the flexible printed wiring boards 10 and 20, but also the function of protecting the joint between the insertion portion 52 and the flexible printed wiring boards 10 and 20.

The cover 6 of the present embodiment includes the main body 61 attached to the housings 3 and 4 so as to cover the insertion portion 52, the first holding portion 62A, the first hinge portion 63A connecting the main body 61 and the first holding portion 62A, the second holding portion 62B, and the second hinge portion 63B connecting the main body 61 and the second holding portion 62B. The cover 6 sandwiches the first flexible printed wiring board 10 between the main body 61 and the first holding portion 62A, sandwiches the second flexible printed wiring board 20 between the main body 61 and the second holding portion 62B, and causes the overlapped first flexible printed wiring board 10 and the second flexible printed wiring board 20 to extend from the slit 66. The slit 66 is a gap between the first holding portion 62A and the second holding portion 62B. The first holding portion 62A and the second holding portion 62B are independent, which improves the workability of retaining the flexible printed wiring boards 10 and 20.

Moreover, the number of the inner housings 4 included in the connector 2 is not limited to four. For example, the first cavity 45 and the second cavity 46 may be provided in the first-shaped housing 4A, and the first cavity 45 and the second cavity 46 may be provided in the second-shaped housing 4B. In this case, the number of the inner housings 4 included in the connector 2 may be two.

The housing of the connector 2 is not necessarily divided into the outer housing 3 and the inner housing 4. For example, the outer housing 3 may be provided with the cavities 45 and 46. The connector 2 is not limited to a lever-type connector with the lever 7.

The cover 6 may be configured such that the main body 61 and the holding portion 62 are not integral. For example, the main body 61 and the holding portion 62 may be separate components. In this case, the main body 61 is first attached to the outer housing 3. Then, as illustrated in FIG. 16, the holding portion 62, which is a separate component, may be attached to the main body 61 or the outer housing 3 while the flexible printed wiring boards 10 and 20 are bended.

### First Modification of Embodiment

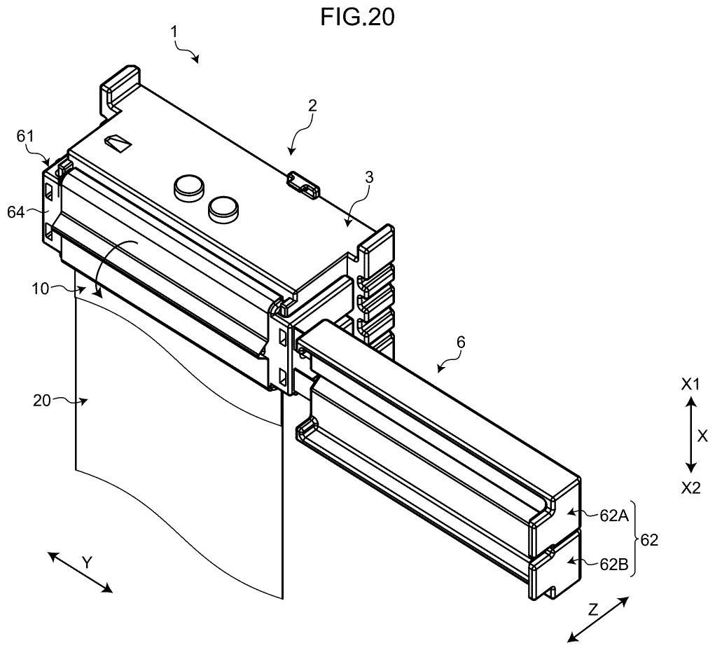

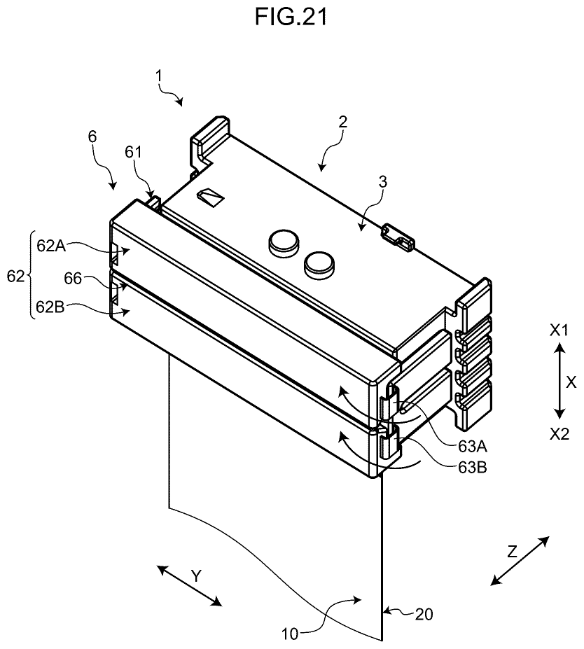

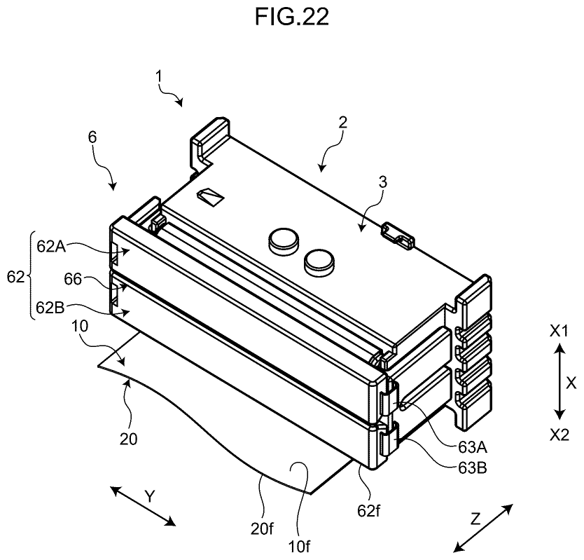

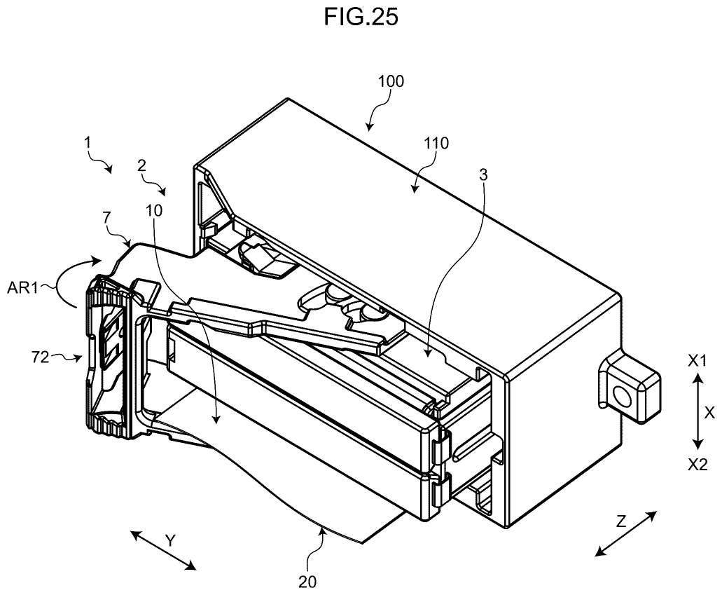

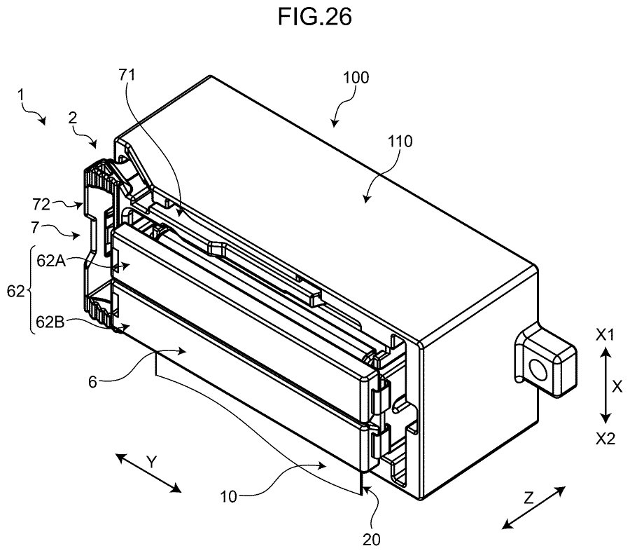

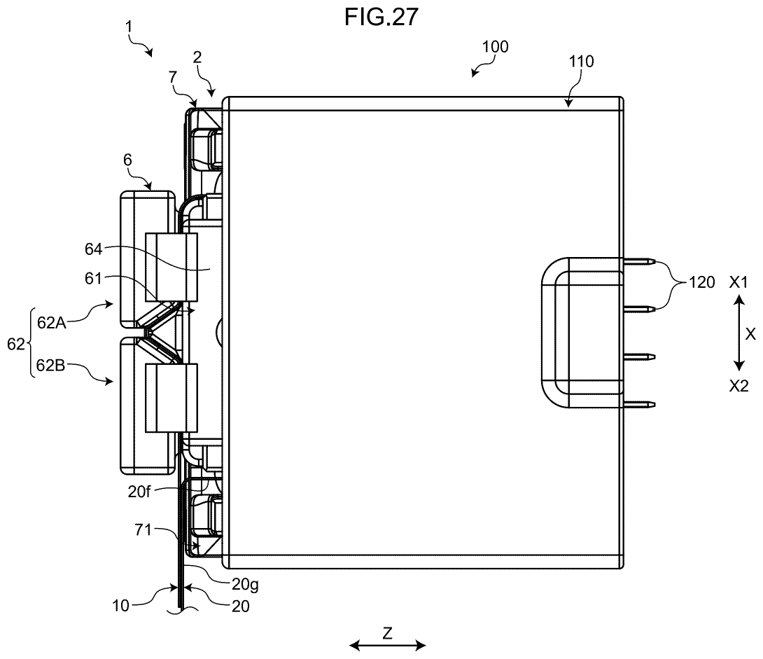

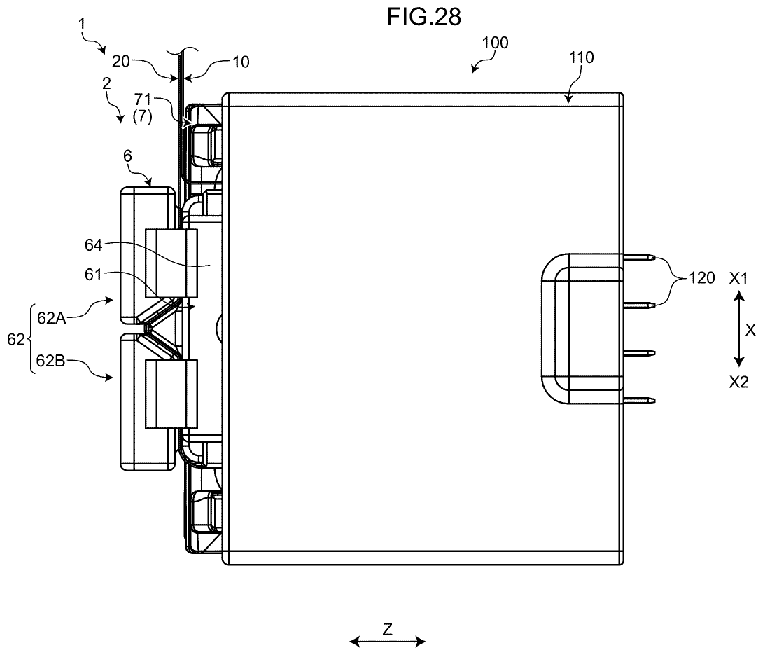

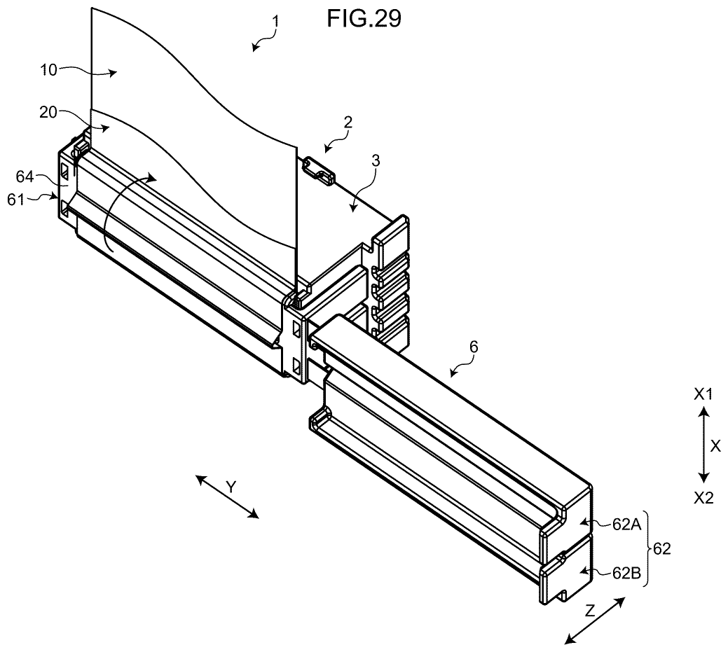

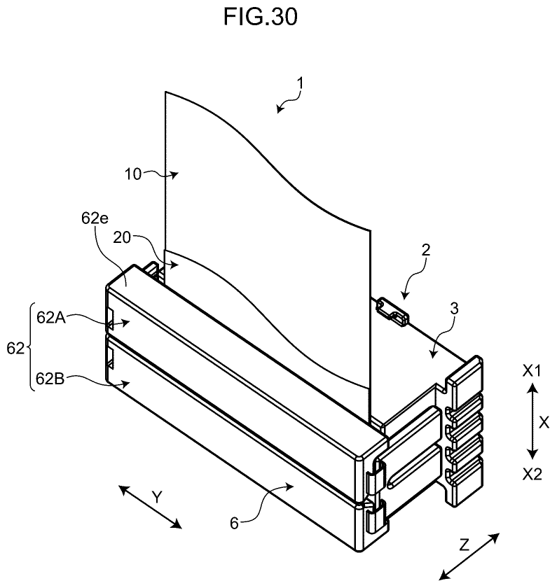

A first modification of the present embodiment is now described. FIG. 20 is a diagram illustrating an operation of bending a wiring board according to the first modification of an embodiment, FIG. 21 is a diagram illustrating an operation of retaining the wiring board according to the first modification of the embodiment, FIG. 22 to FIG. 24 are diagrams illustrating an operation of assembling a lever according to the first modification of the embodiment, FIG. 25 is a diagram illustrating an operation of mating according to the first modification of the embodiment, FIG. 26 is a perspective view illustrating a wire harness completely mated to a mating connector, FIG. 27 is a side view illustrating the wire harness completely mated to the mating connector, FIG. 28 is a side view illustrating the wire harness completely mated to the mating connector, FIG. 29 is a diagram illustrating an operation of bending the wiring board according to the first modification of the embodiment, and FIG. 30 is a diagram illustrating an operation of retaining the wiring board according to the first modification of the embodiment. In the first modification of the embodiment, a difference from the above embodiment is, for example, that flexible printed wiring boards 10 and 20 extend in a first direction X.

The direction in which the two flexible printed wiring boards 10 and 20 extend from the cover 6 may be the first direction X. For example, as illustrated in FIG. 20, the flexible printed wiring boards 10 and 20 may be drawn out from the cover 6 to a second side X2 in the first direction X. In this case, in the operation of bending the wiring boards, the operator bends the first flexible printed wiring board 10 and overlaps the first flexible printed wiring board 10 with the second flexible printed wiring board 20 as illustrated in FIG. 20. The first flexible printed wiring board 10 is bended back so as to be wrapped around the covering portion 64 of the cover 6, and is overlapped with the second flexible printed wiring board 20.

Subsequently, the operation of retaining the wiring board is performed. In the operation of retaining the wiring board, the operator engages the first holding portion 62A and the second holding portion 62B with a main body 61 while bending hinge portions 63A and 63B. This results in the first flexible printed wiring board 10 being sandwiched and retained between the two holding portions 62A and 62B and the covering portion 64.

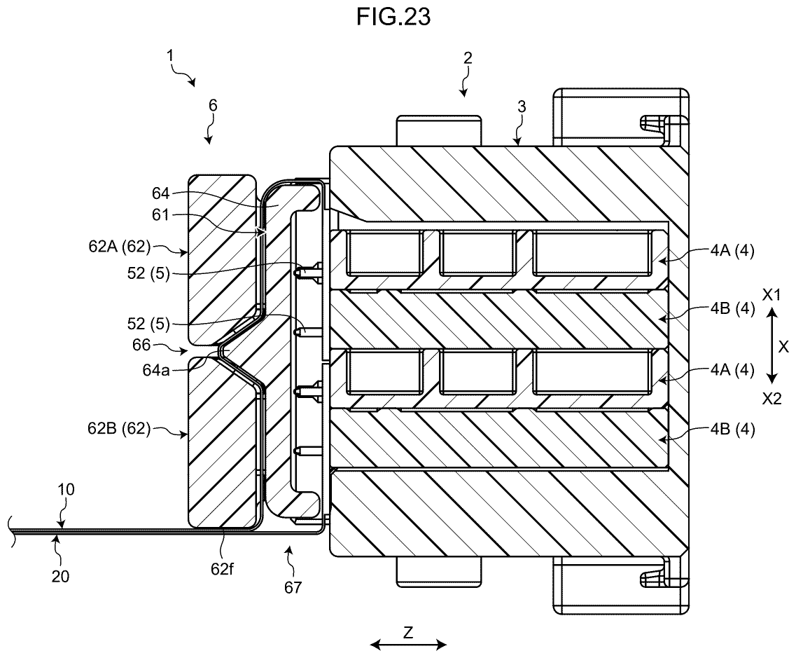

Subsequently, the operation of assembling the lever is performed. In the operation of assembling the lever, the operator bends the two flexible printed wiring boards 10 and 20 so that they are aligned with a side surface 62f of the second holding portion 62B, as illustrated in FIGS. 22 and 23. The flexible printed wiring boards 10 and 20 are bended toward the side opposite to an outer housing 3 in a third direction Z.

As illustrated in FIG. 23, the two flexible printed wiring boards 10 and 20 are drawn out from an end portion 67 of the cover 6. In other words, the end portion 67 of the cover 6 on the second side X2 is used as an exit portion for the flexible printed wiring boards 10 and 20. More specifically, the first flexible printed wiring board 10 extends outward from the cover 6 through a gap between the covering portion 64 and the second holding portion 62B. The second flexible printed wiring board 20 extends outward from the cover 6 through a gap between the covering portion 64 and the outer housing 3.

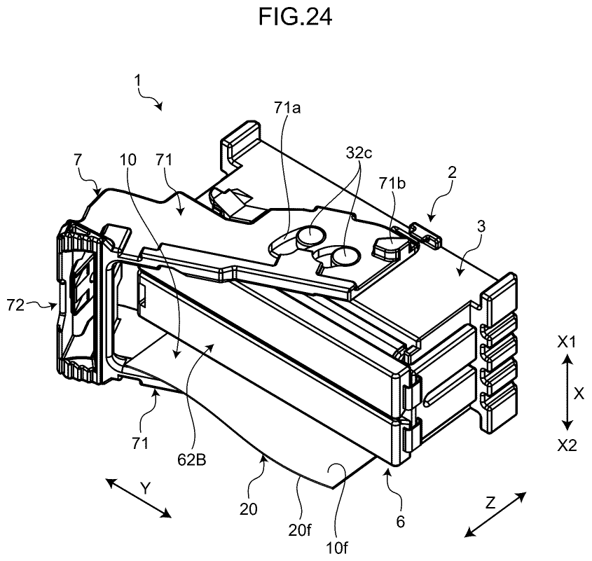

Subsequently, as illustrated in FIG. 24, a lever 7 is attached to the outer housing 3. The lever 7 includes a pair of arms 71 and an operating portion 72. The pair of arms 71 have a plate-like shape and face each other in the first direction X. The operating portion 72 is a portion to which the operational force is applied by an operator. The operating portion 72 connects the pair of arms 71 and extends in the first direction X.

The arm 71 is provided with a guide hole 71a and an abutment portion 71b. The guide hole 71a is an arc-shaped hole into which the shaft portion 32c of the outer housing 3 is inserted. The inner wall of the housing 110 of the mating connector 100 is provided with a support portion for engaging the abutment portion 71b. The abutment portion 71b abuts against the support portion of the mating connector 100 and is engaged by the support portion. The lever 7 rotates about the engaged abutment portion 71b as the center of rotation, thereby mating the outer housing 3 with the housing 110.

As illustrated in FIG. 24, the lever 7 is attached to the outer housing 3 so that the arm 71 is positioned outward relative to the two overlapped flexible printed wiring boards 10 and 20. Thus, the flexible printed wiring boards 10 and 20 extend in the third direction Z through a gap between the arm 71 and the cover 6.

As illustrated in FIG. 25, the outer housing 3 is inserted into the housing 110 of the mating connector 100 along the third direction Z. Upon inserting the outer housing 3 up to the half-mated position, the operator presses the operating portion 72, as indicated by arrow AR1, to rotate the lever 7. The pressing force applied by the operator is transmitted to the outer housing 3 via a force-multiplying mechanism, thereby fully engaging the outer housing 3 with the housing 110.

FIGS. 26 and 27 illustrate the connector 2 fully mated with the mating connector 100. Upon being fully mated, most of the arm 71 of the lever 7 is accommodated within the housing 110. More specifically, as illustrated in FIG. 27, the arm 71 is accommodated within the housing 110 such that it does not overlap the holding portion 62 when viewed from the first direction X. As illustrated in FIG. 27, the gap between the second holding portion 62B and the covering portion 64 is open toward the second side X2. Thus, the cover 6 according to the first modification of the embodiment allows the first flexible printed wiring board 10 to extend linearly toward the second side X2.

The second flexible printed wiring board 20 is drawn out toward the second side X2 so as to pass over the arm 71. More specifically, the second flexible printed wiring board 20 includes a first portion 20f extending in the third direction Z and a second portion 20g extending in the first direction X. The first portion 20f is formed in the gap between the arm 71 and the outer housing 3. The second flexible printed wiring board 20 is bended so as to follow the first flexible printed wiring board 10 at the point where the first portion 20f intersects with the first flexible printed wiring board 10. This allows the second flexible printed wiring board 20 to overlap the first flexible printed wiring board 10. In other words, complete mating of the connector 2 with the mating connector 100 makes it possible to extend the flexible printed wiring boards 10 and 20 linearly toward the second side X2.

In this way, the connector 2 is configured to allow the extension direction of the two flexible printed wiring boards 10 and 20 to be set in the first direction X. Thus, it is possible for the wire harness 1 to flexibly respond to various routing directions upon being mounted on a vehicle.

Moreover, as illustrated in FIG. 28, the connector 2 can also be configured to allow the flexible printed wiring boards 10 and 20 to extend from the cover 6 toward the first side X1. In this case, as illustrated in FIG. 29, in the operation of bending the wiring board, the operator bends the second flexible printed wiring board 20 and overlaps it with the first flexible printed wiring board 10. The second flexible printed wiring board 20 is bended back to wrap around the covering portion 64 of the cover 6, overlapping the first flexible printed wiring board 10.

In the operation of retaining the wiring board, the second flexible printed wiring board 20 is sandwiched and retained between the two holding portions 62A and 62B and the covering portion 64. Subsequently, in the operation of assembling the lever, the two flexible printed wiring boards 10 and 20 are bended so as to align with a side surface 62e of the first holding portion 62A, and the lever 7 is attached to the outer housing 3. The complete mating of the connector 2 with the mating connector 100, as illustrated in FIG. 28, makes it possible to extend the overlapped flexible printed wiring boards 10 and 20 linearly toward the first side X1.

### Second Modification of Embodiment

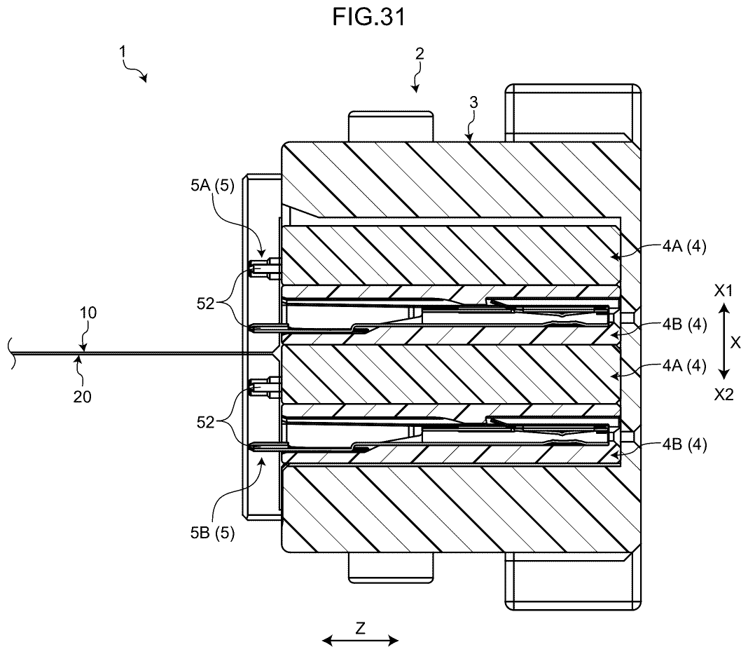

A second modification of the present embodiment is now described. FIG. 31 is a cross-sectional view of a wire harness according to the second modification of the embodiment. The second modification of the present embodiment differs from the embodiments previously mentioned in that, for example, the orientation of attachment of flexible printed wiring boards 10 and 20 to a terminal 5. The first flexible printed wiring board 10 illustrated in FIG. 31 is joined to the first terminal group 5A so as to extend from the first terminal group 5A to the second side X2. The second flexible printed wiring board 20 is joined to the second terminal group 5B so as to extend from the second terminal group 5B to the first side X1.

The two flexible printed wiring boards 10 and 20 are bended in the third direction Z and overlapped at a position between the first terminal group 5A and the second terminal group 5B. The connector 2 of the second modification may include a holding member attached to the outer housing 3 to cause the two flexible printed wiring boards 10 and 20 to extend in the third direction Z.

The connector 2 may be configured as a shielded connector. In this case, a conductive shielding layer may be provided in the first flexible printed wiring board 10 and the second flexible printed wiring board 20. With the two flexible printed wiring boards 10 and 20 being overlapped, the shielding layer is disposed on the outside. The shielding layer may be a conductive paste applied to the outer surface of base films 11 and 21.

In the case where the connector 2 is configured as a shielded connector, the connector 2 may include a conductive portion that grounds the shielding layer. The conductive portion for grounding can ground the shielding layer of the flexible printed wiring boards 10 and 20 to a metallic housing or the like. The conductive portion for grounding may be a conductive member provided in the outer housing 3, or may be a shielding shell that covers the outer housing 3.

The disclosures set forth in the previously mentioned embodiments and modifications can be implemented in appropriate combinations.

The wire harness according to the present embodiment includes a holding member attached to a housing and configured to retain a first flexible printed wiring board and a second flexible printed wiring board. The holding member has an exit portion to cause the first flexible printed wiring board and the second flexible printed wiring board, which are overlapped with each other, to extend from the exit portion. The wire harness according to the present embodiment allows the two flexible printed wiring boards to be overlapped and extend outward, achieving improved ease of handling.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a connector that includes a plurality of terminals and a housing, each of the terminals having a rod-shaped or tubular insertion portion, the housing retaining the terminals arranged in a plurality of rows aligned in a first direction with the insertion portion protruding, the terminals including a first terminal group disposed on a first side in the first direction and a second terminal group disposed on a second side in the first direction;
a first flexible printed wiring board that includes a through-hole into which the insertion portion of the first terminal group is inserted and a printed circuit connected to the insertion portion of the first terminal group;
a second flexible printed wiring board that includes a through-hole into which the insertion portion of the second terminal group is inserted and a printed circuit connected to the insertion portion of the second terminal group; and
a holding member attached to the housing and configured to retain the first flexible printed wiring board and the second flexible printed wiring board, wherein
the first flexible printed wiring board and the second flexible printed wiring board are overlapped with each other by bending at least one of the first flexible printed wiring board and the second flexible printed wiring board, and
the holding member has an exit portion and causes the first flexible printed wiring board and the second flexible printed wiring board, overlapped with each other, to extend from the exit portion.

2. The wire harness according to claim 1, wherein
the holding member retains the first flexible printed wiring board and the second flexible printed wiring board in respective bended states and causes the first flexible printed wiring board and the second flexible printed wiring board, overlapped with each other, to extend from the exit portion toward a protruding direction of the insertion portion.

3. The wire harness according to claim 1, wherein
the holding member has a main body, a holding portion, and a hinge portion, the main body being attached to the housing to cover the insertion portion, the hinge portion connecting the main body and the holding portion, and
the holding member sandwiches the first flexible printed wiring board and the second flexible printed wiring board between the main body and the holding portion to cause the first flexible printed wiring board and the second flexible printed wiring board to overlap with each other.

4. The wire harness according to claim 2, wherein
the holding member has a main body, a first holding portion, a first hinge portion, a second holding portion, and a second hinge portion, the main body being attached to the housing to cover the insertion portion, the first hinge portion connecting the main body and the first holding portion, the second hinge portion connecting the main body and the second holding portion, and
the holding member sandwiches the first flexible printed wiring board between the main body and the first holding portion, sandwiches the second flexible printed wiring board between the main body and the second holding portion, and causes the first flexible printed wiring board and the second flexible printed wiring board, overlapped with each other, to extend from a gap between the first holding portion and the second holding portion.
